(19) United States
(12) Patent Application Publication
(10) Pub. No.: US 2017/0024809 A1
(43) Pub. Date: Jan. 26, 2017

(54) Generating an Interface Hierarchy For Use in an Auction

(71) Applicant: Jacob Baskin, Brooklyn, NY (US)

(72) Inventor: Jacob Baskin, Brooklyn, NY (US)

(21) Appl. No.: 13/528,404

(22) Filed: Jun. 20, 2012

(51) Int. Cl. G06Q 30/08

(52) U.S. Cl. CPC G06Q 30/08

(57) ABSTRACT

A method performed by one or more processing devices includes retrieving information indicative of a plurality of stages in an auction for content items; retrieving an interface hierarchy including a plurality of interfaces; wherein an interface, from the plurality, is associated with a stage in the auction and specifies one or more operations to be performed at the stage; retrieving information indicative of a content item participating in the auction; identifying a stage to which the content item has progressed; associating the content item with an interface associated with the stage identified; performing one or more operations specified by the interface associated with the content item; and populating, based on performing, the interface associated with the content item with information for the stage identified.

### BACKGROUND

A web page may display content items. An advertisement is an example of a content item. In an example, a system executes an auction to select content items for display in the web page. Generally, an auction includes a technique for allocating content items to slots. Generally, a slot includes a portion of a graphical user interface in which content items can be presented.

In this example, the auction includes various stages, including, e.g., a stage in which content items are prepared for participation in the auction, a stage in which bid prices are compared to publisher pricing information, a stage in which content items are ranked, a stage in which a content item is selected as a winner of the auction, and so forth. Generally, a bid price includes an amount that a content provider will pay for presentation of a content item in a slot. Generally, a publisher includes an entity that controls, manages and/or owns a resource.

Generally, a resource includes item(s) of data that can be provided over a network. Resources include HTML pages, web pages, websites, word processing documents, portable document format (PDF) documents, images, videos, applications, and so forth. Generally, publisher pricing information includes information indicative of an amount that a publisher will accept, from a content provider, for presentation of a content item in a slot of a resource of the publisher.

In an example, a system represents a content item, participating in an auction, as an object. The object may include state information, e.g., information indicative of condition of the object. For example, state information may include information indicative of whether a bid price for a content item complies with publisher pricing information. The system implements the auction by maintaining state information for the object, e.g., as the object progresses through the various stages of the auction.

In an example, the system consumes numerous resources in identifying an outcome of an auction. For example, the system parses through state information of numerous objects to identify an item of state information indicative of a winner of the auction. In another example, the system consumes numerous resources in identifying a stage in which an object is disqualified from participating in an auction. In this example, the system parses through state information of an object to identify an item of state information indicative of a stage in which the content item was disqualified.

### SUMMARY

In one aspect of the present disclosure, a method performed by one or more processing devices includes retrieving information indicative of a plurality of stages in an auction for content items; retrieving an interface hierarchy including a plurality of interfaces; wherein an interface, from the plurality, is associated with a stage in the auction and specifies one or more operations to be performed at the stage; retrieving information indicative of a content item participating in the auction; identifying a stage to which the content item has progressed; associating the content item with an interface associated with the stage identified; performing one or more operations specified by the interface associated with the content item; and populating, based on performing, the interface associated with the content item with information for the stage identified.

Implementations of the disclosure can include one or more of the following features. In some implementations, actions of identifying, associating, performing and populating are repeated until the content item is identified as a winner of the auction or is rejected from the auction. In other implementations, the method includes determining, based on the interface associated with the content item, that the content item is a winner of the auction. In still other implementations, the method includes determining, based on the interface associated with the content item, that the content item is rejected from the auction.

In some implementations, the method includes determining, from the interface associated with the content item, a reason why the content item is rejected from the auction. In other implementations, the content item includes a first content item, the interface includes a first interface, the stage to which the first content item has progressed includes a first stage, and the method further includes: identifying a second stage to which a second content item has progressed; associating the second content item with a second interface associated with the second stage; performing one or more operations specified by the second interface; and populating, based on performing the one or more operations specified by the second interface, the second interface with information for the second stage.

In other implementations, the auction is executed by performing first actions in parallel with second actions; the first actions include: identifying the first stage; associating the first content item with the first interface for the first stage; performing the one or more operations specified by the first interface; and populating, based on performing the one or more operations specified by the first interface, the first interface with information for the first stage; and the second actions include: identifying the second stage; associating the second content item with the second interface for the second stage; performing the one or more operations specified by the second interface; and populating, based on performing the one or more operations specified by the second interface, the second interface with information for the second stage.

In other implementations, retrieving the information indicative of the plurality of stages includes: retrieving a directed graph including a plurality of nodes that are ordered in accordance with the stages of the auction; wherein a node represents a stage; wherein identifying the stage to which the content item has progressed includes: identifying a node that is ordered before other nodes in the directed graph.

In still another aspect of the disclosure, one or more machine-readable media are configured to store instructions that are executable by one or more processing devices to perform operations including retrieving information indicative of a plurality of stages in an auction for content items; retrieving an interface hierarchy including a plurality of interfaces; wherein an interface, from the plurality, is associated with a stage in the auction and specifies one or more operations to be performed at the stage; retrieving information indicative of a content item participating in the auction; identifying a stage to which the content item has progressed; associating the content item with an interface associated with the stage identified; performing one or more operations specified by the interface associated with the content item; and populating, based on performing, the interface associated with the content item with information for the stage identified. Implementations of this aspect of the present disclosure can include one or more of the foregoing features.

In still another aspect of the disclosure, an electronic system includes one or more processing devices; and one or more machine-readable media configured to store instructions that are executable by the one or more processing devices to perform operations including: retrieving information indicative of a plurality of stages in an auction for content items; retrieving an interface hierarchy including a plurality of interfaces; wherein an interface, from the plurality, is associated with a stage in the auction and specifies one or more operations to be performed at the stage; retrieving information indicative of a content item participating in the auction; identifying a stage to which the content item has progressed; associating the content item with an interface associated with the stage identified; performing one or more operations specified by the interface associated with the content item; and populating, based on performing, the interface associated with the content item with information for the stage identified. Implementations of this aspect of the present disclosure can include one or more of the foregoing features.

All or part of the foregoing can be implemented as a computer program product including instructions that are stored on one or more non-transitory machine-readable storage media, and that are executable on one or more processing devices. All or part of the foregoing can be implemented as an apparatus, method, or electronic system that can include one or more processing devices and memory to store executable instructions to implement the stated operations.

The details of one or more implementations are set forth in the accompanying drawings and the description below. Other features, objects, and advantages will be apparent from the description and drawings, and from the claims.

### DESCRIPTION OF DRAWINGS

FIG. 1A is a diagram of an example of a network environment for executing an auction with an interface hierarchy.

FIG. 1B is a diagram of a visual representation of an interface hierarchy auction program.

FIG. 2 is a block diagram showing examples of components of a network environment for executing an auction with an interface hierarchy.

FIG. 3 is a flowchart showing a process for executing an auction with an interface hierarchy.

FIG. 4 shows an example of a computer device and a mobile computer device that can be used to implement the techniques described herein.

Like reference symbols in the various drawings indicate like elements.

### DETAILED DESCRIPTION

Described herein is a system that generates an interface hierarchy for use in an auction. Generally, an interface hierarchy includes an ordered set of interfaces. Generally, an interface includes a structure for exposure of operations and storage of information, including, e.g., information generated using the exposed operations.

The interface hierarchy exposes various interfaces to candidates of an auction, e.g., during various stages of the auction. Generally, a candidate includes a content item that is included in an auction. In an auction, a candidate is represented as an object. Hereinafter, for purposes of convenience and without limitation, an object shall also be referred to as a candidate.

In an example, candidates in an auction go through various, different stages over the course of the auction. For example, in one stage, a bid price for the candidate is converted to a common currency. In another stage, bid prices are compared with a publisher's price floors. In still another stage, bid prices are ranked. In yet another stage, one of the bid prices is accepted.

Different types of information are required to accompany a candidate, e.g., for completion of each stage of the auction. In some examples, the system may be unable to determine whether or not a given candidate has the required accompanying information. For example, this determination may be particularly problematic when there are multiple paths through the auction process.

For example, some content items may be sold on a fixed-price basis that require the content items to proceed through various auction stages. Other content items may be sold on an adjustable-price basis that require the content items to proceed through other, different auction stages. The foregoing problems in determining whether or not a given candidate has the required accompanying information may lead to incorrect auction results.

To promote accurate accompaniment of required information at each stage of an auction, the system uses the interface hierarchy. Through the interface hierarchy, the system promotes a consistent flow of information through the auction, e.g., independent of a path that a candidate takes through the auction process. For example, through the interface hierarchy, the system is configured to associate a candidate, at a particular stage in the auction process, with the information required for the candidate at the particular stage.

For example, rather than maintaining state information for the candidate, the system is configured to associate the candidate with various interfaces at various stages of an auction. For example, at one stage, the system associates the candidate with one interface. At another stage, the system associates the candidate with another, different interface.

In an example, an interface may specify operations that are available to the system. Using a specified operation, the system collects and/or generates information for a candidate in a particular stage of the auction. Through the interface, the system updates the candidate with the collected information.

Based on an interface associated with a candidate, the system may determine a stage to which the candidate has progressed. Additionally, based on information associated with the candidate and the interface, the system may identify information associated with the stage to which the candidate has progressed.

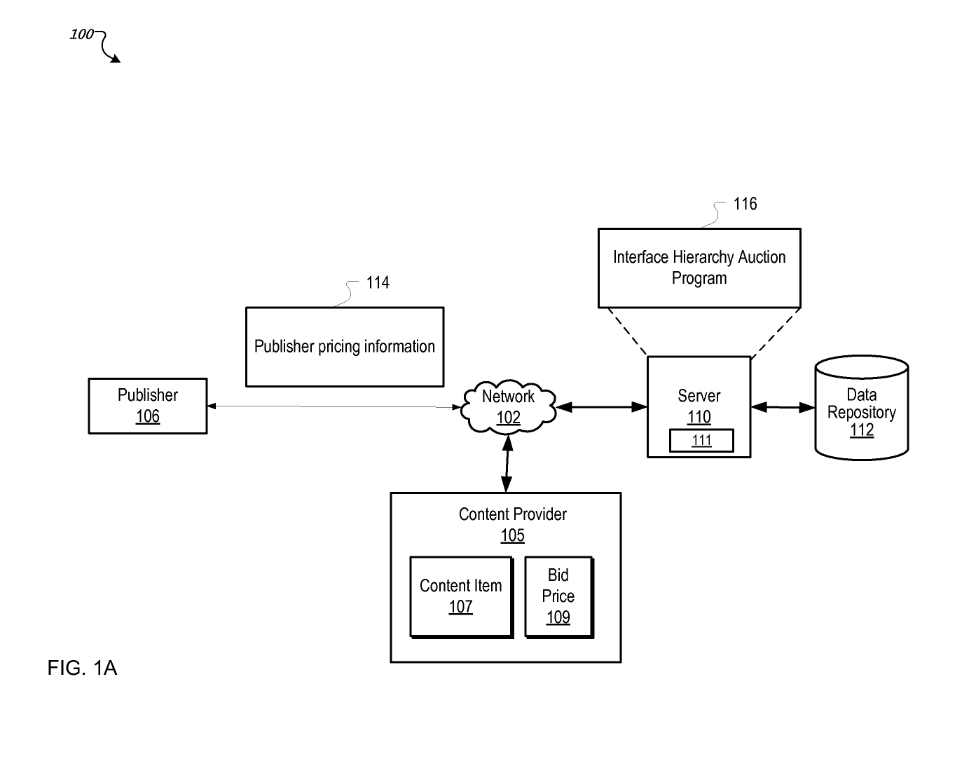

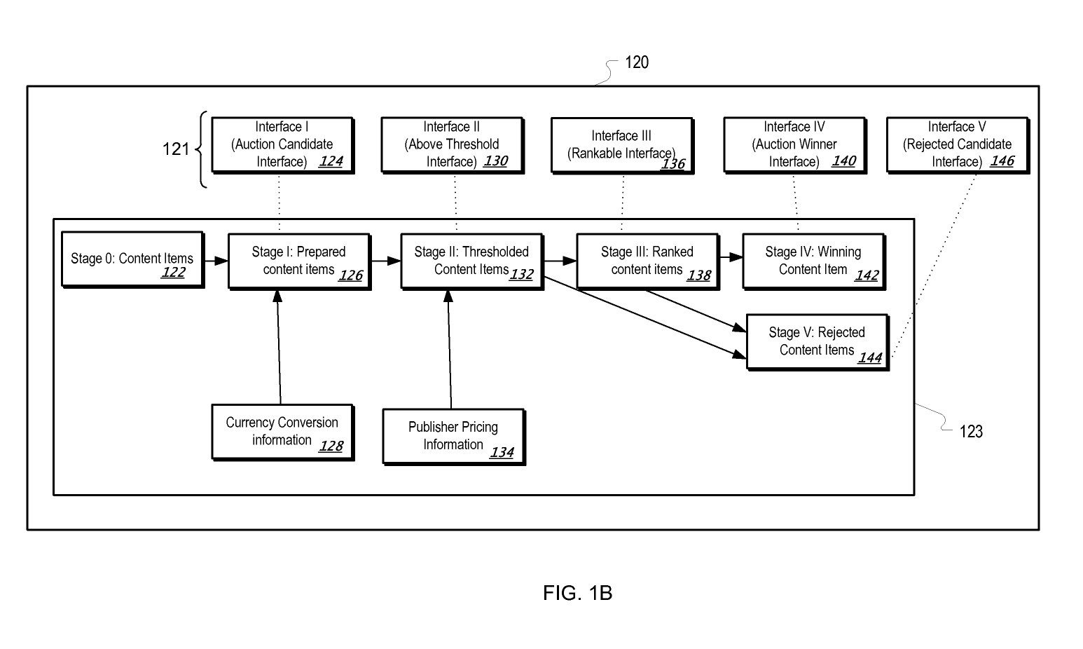

FIG. 1A is a diagram of an example of network environment 100 for executing an auction with an interface hierarchy. Network environment 100 includes network 102, publisher 106, content provider 105, server 110 and data repository 112.

Publisher 106 and content provider 105 can communicate with server 110 over network 102. Network environment 100 may include many thousands of data repositories, publishers, content providers and servers, which are not shown. Server 110 may include various data engines, including, e.g., data engine 111. Although data engine 111 is shown as a single component in FIG. 1, data engine 111 can exist in one or more components, which can be distributed and coupled by network 102.

In the example of FIG. 1, publisher 106 transmits, to server 110, publisher pricing information 114. Content provider 105 transmits, to server 110, content item 107 and bid price 109 for content item 107. Data engine 111 stores, in data repository 112, content item 107, bid price 109 and publisher pricing information 114.

Using publisher pricing information 114 and bid prices for content items (e.g., bid price 109 for content item 107), data engine 111 executes an auction. In an example, data engine 111 accesses interface hierarchy auction program 116 for execution of the auction. Generally, interface hierarchy auction program 116 includes a set of instructions for implementing an auction in accordance with an interface hierarchy.

FIG. 1B is a diagram of visual representation 120 of interface hierarchy auction program 116. Visual representation 120 includes directed graph 123 and interface hierarchy 121. Generally, a directed graph includes a set of nodes, a set of edges connecting the nodes, and set of instructions specifying an order in which the nodes and the edges are traversed. In this example, the stages of an auction are represented as nodes 122, 126, 132, 138, 142 in directed graph 123. Directed graph 123 also includes nodes 128, 134 to represent various information that is retrieved at various stages of an auction.

In the example of FIG. 1B, interface hierarchy auction program 116 is implemented as directed graph 123 in association with interface hierarchy 121. Interface hierarchy 121 includes interfaces 124, 130, 136, 140, 146. An interface exposes operations to be implemented, by data engine 111, in a particular stage of an auction.

In an example, content item 107 is a candidate in an auction. At various stages of the auction, content item 107 is associated with one of interfaces 124, 130, 136, 140, 146. Through an association between content item 107 and one of interfaces 124, 130, 136, 140, 146, data engine 111 may identify a stage to which content item 107 has progressed.

In an example, an auction includes six stages, including, e.g., stages 0, I, II, III, IV, V. In stage 0, data engine 111 retrieves, from data repository 112, information indicative of bid prices for content items (e.g., bid price 109 for content item 107). In directed graph 123, node 122 represents stage 0.

Following completion of stage 0 at node 122, data engine 111 traverses to node 126. Node 126 represents stage I, in which content items are prepared for participation in the auction. Node 126 is associated with interface 124. In an example, node 126 may be associated with interface 124 through a pointer or link. Generally, a pointer includes a structure that causes one item of data to reference another item of data.

Interface 124 includes information indicative of various operations to be executed by data engine 111 in stage I. In an example, the operations provided by interface 124 include techniques for preparing the content items and associated bid prices for participation in the auction. In an example, data engine 111 prepares the content items and bid prices by converting bid prices to a common currency. In this example, the bid prices may by in numerous, different currencies.

To convert the bid prices to a common currency, interface 124 includes operations for instructing data engine 111 to retrieve, from data repository 112, currency conversion information (not shown). Generally, currency conversion information includes information indicative of conversation rates among various currencies. Node 128 represents the currency conversion information that is retrieved from data repository 112.

Interface 124 also includes operations for instructing data engine 111 on how to apply the currency conversion information to bid price 109. In this example, data engine 111 applies the operations to bid price 109, e.g., to convert bid price 109 to the common currency.

Through interface 124, data engine 111 collects information needed at stage I, e.g., the currency conversion information. Using the operations in interface 124, data engine 111 also generates the information that is appropriate for stage I, e.g., a conversion of bid price 109 to a common currency.

Following completion of stage I at node 126, data engine 111 traverses directed graph 123 to node 132. Node 132 is associated with stage II of the auction, in which a determination is made regarding compliance of bid price 109 with publisher pricing information 114. In an example, publisher pricing information 114 includes a threshold price (e.g., a predefined price). In this example, bid price 109 complies with publisher pricing information 114 when bid price 109 is equal to or greater than the threshold price. In this example, content item 107 is a thresholded content item. Generally, a thresholded content item includes a content item associated with a bid price that is equal to or greater than with a threshold price specified in publisher pricing information.

Node 132 is also associated with interface 130. Interface 130 includes numerous operations to be implemented in stage II of the auction. In an example, an operation exposed in interface 130 includes an instruction to retrieve publisher pricing information 114, e.g., from data repository 112. Node 134 represents publisher pricing information 114 that is retrieved from data repository 112.

The operations exposed in interface 130 also include techniques for identifying thresholded content items. In an example, one of the operations includes comparing a threshold price to bid price 109. Based on application of the operation, data engine 111 determines if content item 107 includes a thresholded content item.

Following completion of stage II at node 132, data engine 111 traverses directed graph 123 to node 144 or to node 138. In an example, at stage II, data engine 111 determines that content item 107 fails to include a thresholded content item (e.g., bid price 109 is less than a threshold price specified in publisher pricing information 114). In this example, data engine 111 traverses directed graph 123 to node 144.

Node 144 is associated with stage V of an auction. In stage V, content items are rejected from the auction. Node 144 is associated with interface 146. Interface 146 represents a content item that is rejected in an auction. Interface 146 also includes a field that may be populated, by data engine 111, with information specifying a reason for the rejection. Generally, a field includes a portion of a data structure for storage of information. For example, a reason may include that bid price 109 of content item 107 is less than the threshold price, that content item 107 is ranked below other content items participating in the auction, and so forth.

In another example, at stage II represented by node 132, data engine 111 determines that content item 107 includes a thresholded content item (e.g., bid price 109 is equal to or greater than the threshold price). In this example, data engine 111 traverses directed graph 123 to node 138. Node 138 is associated with stage III of the auction, in which content items are ranked.

Node 138 is associated with interface 136. Interface 136 provides operations to be implemented, by data engine 111, at stage III. In an example, the operations include techniques for ranking remaining content items in the auction. Using the operations specified in interface 136, data engine 111 ranks the remaining content items in the auction.

Using results of the ranking, data engine 111 traverses directed graph 123 to either node 142 or node 144. In an example, content item 107 is a winner of the auction. In this example, data engine 111 traverses directed graph 123 from node 138 to node 142. Node 142 is associated with stage IV of an auction, in which a content item is identified as a winner. Node 142 is also associated with interface 140.

Interface 140 includes operations to be implemented at stage IV, including, e.g., techniques for customizing contents of a winning content item. Interface 140 also includes information specifying that content item 107 won the auction. Interface 140 also includes a field to be populated, by data engine 111, with information indicative of a winning bid price (e.g., bid price 109) for content item 107.

In another example, content item 107 is not the winner of the auction. In this example, data engine 111 traverses directed graph 123 from node 138 to node 144. At node 144, content item 107 is associated with interface 146. As previously described, interface 146 includes information that specifies that content item 107 was rejected from the auction. Interface 146 also includes a field to be populated, by data engine 111, with information specifying why content item 107 was rejected from the auction. In this example, the field is populated with information specifying that other content items were ranked above content item 107 in the auction.

In an example, the information generated through one or more of interfaces 124, 130, 136, 140, 146 may be inherited among interfaces 124, 130, 136, 140, 146. In an example, at stage I represented by node 126, content item 107 is associated with interface 124. As previously described, interface 124 may include various information, including, e.g., bid price 109 that has been converted to a common currency. In this example, interface 130 inherits at least part of the information in interface 124. For example, bid price 109 that has been converted to a common currency is inherited by interface 130 from interface 124. Interface 130 uses bid price 109 that has been converted to a common currency to determine if content item 107 is a thresholded content item.

In this example, information is inherited from interface 124 to interface 130. The inherited information is an input to node 132, which is associated with interface 130. Data engine 111 is configured to traverse from node 126 to node 132, e.g., when the input to node 132 becomes valid (e.g., the input has been generated). By allowing traversal to node 132 once inputs to node 132 are valid, interface hierarchy auction program 116 promotes collection of appropriate information at each stage of the auction. For example, data engine 111 is prevented from traversing to node 132 until the input to node 132 is valid (e.g., until appropriate information is collected and/or generated at node 126).

In another example, through interface hierarchy 121, data engine 111 may determine whether content item 107 is a winner of the auction. In this example, data engine 111 identifies whether content item 107 is associated with interface 140 or with interface 146. When content item 107 is associated with interface 140, data engine 111 identifies content item 107 as a winner of the auction. When content item 107 is associated with interface 146, data engine 111 identifies content item 107 as having been rejected from the auction. Additionally, based on contents of interface 146, data engine 111 may identify a reason for the rejection of content item 107.

In an example, an auction includes numerous, different candidates. In this example, different candidates may follow different paths in directed graph 123, e.g., between the start and the end of the auction. The different candidates may follow different paths by traversing different combinations of nodes 122, 126, 132, 138, 142, 144 in directed graph 123.

For example, one candidate may follow a first path through directed graph 123. In the first path, the candidate traverses nodes 122, 126, 132, 144. Another candidate may follow a second, different path in directed graph 123, in which traversal occurs through nodes 122, 126, 132, 138, 142.

In this example, interfaces 124, 130, 136, 140, 146 ensure that required operations are performed at each stage of the auction, e.g., independent of the path that a candidate follows through directed graph 123. For example, in the first path, interfaces 124, 130, 146 promote performance of the various operations required in each of stages 0, I, II and V of an auction. In the first path, interfaces 124, 130, 146 also promote performance of these various operations at an appropriate stage in the auction. For example, in the first path, interface 124 promotes performance of operations necessary for stage I of the auction.

In the second path, interfaces 124, 130, 136, 140 promote performance of the various operations required in each of stages 0, I, II, III and IV of an auction. In the second path, interfaces 124, 130, 136, 140 also promote performance of these various operations at an appropriate stage in the auction. For example, interface 124 promotes performance of operations necessary for stage I of the auction, e.g., during traversal by a candidate through the second path.

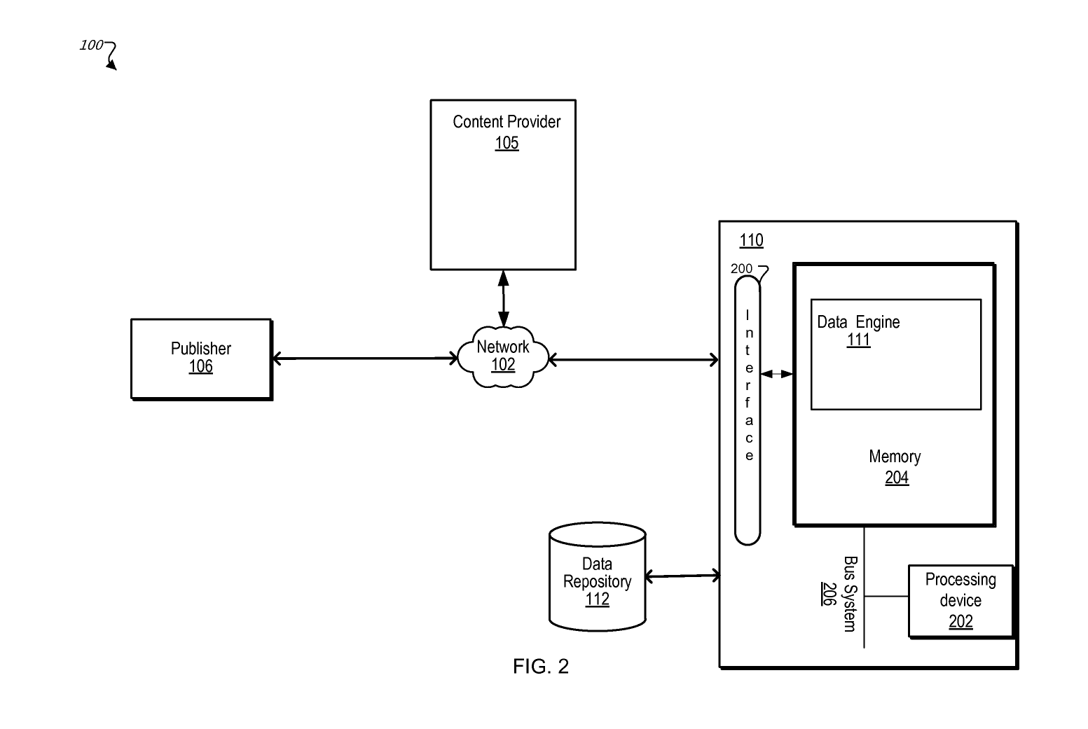

FIG. 2 is a block diagram showing examples of components of network environment 100 for executing an auction with an interface hierarchy. In the example of FIG. 2, publisher pricing information 114, content item 107, bid price 109 and interface hierarchy auction program 116 are not shown.

One or more of publisher 106 and content provider 105 can be a computing device capable of taking input from a user and communicating over network 102 with server 110 and/or with other computing devices. For example, one of publisher 106 and content provider 105 can be a mobile device, a desktop computer, a laptop, a cell phone, a personal digital assistant (PDA), a server, an embedded computing system, a mobile device, and the like. Network environment 100 can include a plurality of computing devices, which can be geographically dispersed.

Network 102 can include a large computer network, including, e.g., a local area network (LAN), wide area network (WAN), the Internet, a cellular network, or a combination thereof connecting a number of mobile computing devices, fixed computing devices, and server systems. The network(s) may provide for communications under various modes or protocols, including, e.g., Transmission Control Protocol/Internet Protocol (TCP/IP), Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. Communication may occur through a radio-frequency transceiver. In addition, short-range communication may occur, including, e.g., using a Bluetooth, WiFi, or other such transceiver.

Server 110 can be a variety of computing devices capable of receiving data and running one or more services. In an example, server 110 can include a server, a distributed computing system, a desktop computer, a laptop, a cell phone, a rack-mounted server, and the like. Server 110 can be a single server or a group of servers that are at a same location or at different locations. Publisher 106 (or content provider 105) and server 110 can run programs having a client-server relationship to each other. Although distinct modules are shown in the figures, in some examples, client and server programs can run on the same device.

Server 110 can receive data from publisher 106 and content provider 105 (and/or from data repository 112) through input/output (I/O) interface 200. I/O interface 200 can be a type of interface capable of receiving data over a network, including, e.g., an Ethernet interface, a wireless networking interface, a fiber-optic networking interface, a modem, and the like. Server 110 also includes a processing device 202 and memory 204. A bus system 206, including, for example, a data bus and a motherboard, can be used to establish and to control data communication between the components of server 110.

Processing device 202 can include one or more microprocessors. Memory 204 can include a hard drive and a random access memory storage device, including, e.g., a dynamic random access memory, or other types of non-transitory machine-readable storage devices. As shown in FIG. 2, memory 204 stores computer programs that are executable by processing device 202. These computer programs include data engine 111. Data engine 111 can be implemented in software running on a computer device (e.g., server 110), hardware or a combination of software and hardware.

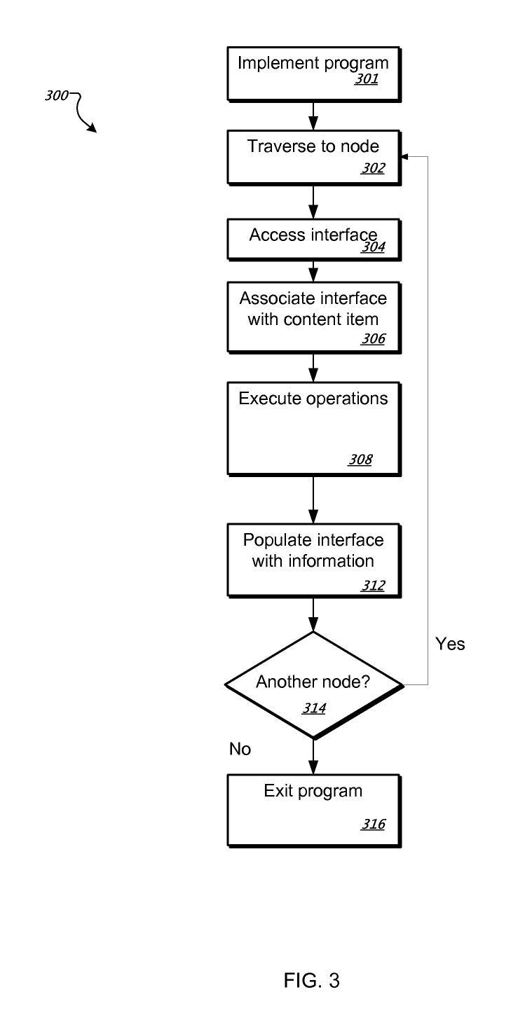

FIG. 3 is a flowchart showing an example process 300 for executing an auction with an interface hierarchy. Process 300 is performed on server 110 (and/or by data engine 111 on server 110).

In operation, interface hierarchy auction program 116 is implemented for content item 107 (301). For example, data engine 111 implements (301) interface hierarchy auction program 116 as directed graph 123 with interface hierarchy 121. As previously described, directed graph 123 includes nodes 122, 126, 132, 138, 142 for traversal.

A node is traversed (302). For example, data engine 111 traverses (302) directed graph 123 to node 126. An interface is accessed (304). For example, data engine 111 accesses (304) interface 124 that is associated with node 126.

Interface 124 is associated with content item 107 (306). For example, data engine 111 associates (306) interface 124 with content item 107. Through the association, data engine 111 collects and/or generates information for content item 107 in stage I of the auction.

Interface 124 includes numerous operations, e.g., to be performed at stage I of the auction. The operations of interface 124 are executed (308). For example, data engine 111 executes (308) the operations specified by interface 124.

In an example, interface 124 includes an operation for retrieving information, including, e.g., currency conversation information. Interface 124 also includes another operation for generating information for content item 107, e.g., generating a conversion of bid price 109 to a common currency.

Interface 124 is populated with the information collected and/or generated (312). For example, data engine 111 populates fields in interface 124 with the information collected and/or generated. For example, a field in interface 124 may be populated with a conversion of bid price 109 to a common currency. As previously described, contents of the field in interface 124 may be inherited by another interface, e.g., interface 130.

A determination is made regarding whether directed graph 123 includes another node for traversal (314). In an example, data engine 111 determines (314) that directed graph 123 includes another node, e.g., node 132. In this example, data engine 111 traverses directed graph 123 from node 126 to node 132. As previously described, data engine 111 is configured to move to node 132, e.g., when the inputs to node 132 are valid. In an example, the inputs to node 132 are valid when data engine 111 generates the conversion of bid price 109 to a common currency.

In another example, data engine 111 determines (314) that another node is not included in directed graph 123. In this example, data engine 111 may have traversed directed graph 123 to node 144, in which content item 107 is rejected from the auction. In this example, interface hierarchy auction program 116 is exited (316). For example, data engine 111 exits (316) interface hierarchy auction program 116.

In an example, an auction includes numerous content items (e.g., hundreds or thousands of content items). In this example, data engine 111 is configured to execute the auction by performing process 300 in parallel for the numerous content items.

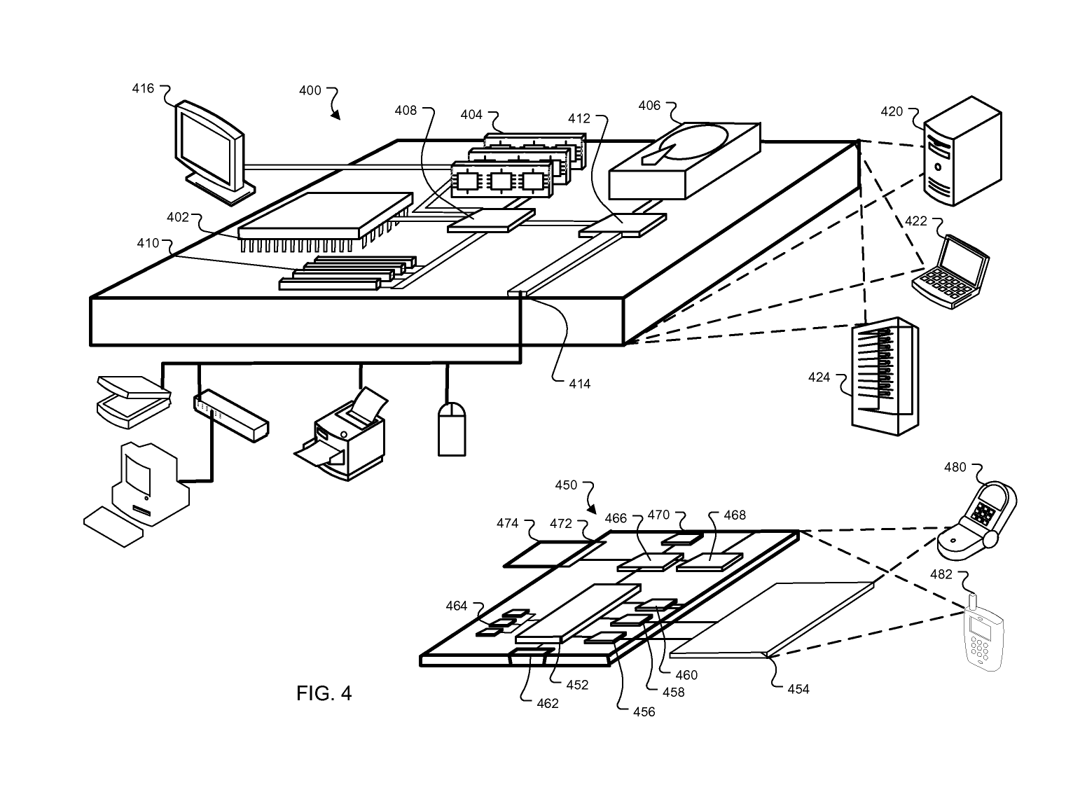

FIG. 4 shows an example of computer device 400 and mobile computer device 450, which can be used with the techniques described here. Computing device 400 is intended to represent various forms of digital computers, such as laptops, desktops, workstations, personal digital assistants, servers, blade servers, mainframes, and other appropriate computers. Computing device 450 is intended to represent various forms of mobile devices, such as personal digital assistants, cellular telephones, smartphones, and other similar computing devices. The components shown here, their connections and relationships, and their functions, are meant to be examples only, and are not meant to limit implementations of the techniques described and/or claimed in this document.

Computing device 400 includes processor 402, memory 404, storage device 406, high-speed interface 408 connecting to memory 404 and high-speed expansion ports 410, and low speed interface 412 connecting to low speed bus 414 and storage device 406. Each of components 402, 404, 406, 408, 410, and 412, are interconnected using various busses, and can be mounted on a common motherboard or in other manners as appropriate. Processor 402 can process instructions for execution within computing device 400, including instructions stored in memory 404 or on storage device 406 to display graphical data for a GUI on an external input/output device, such as display 416 coupled to high speed interface 408. In other implementations, multiple processors and/or multiple buses can be used, as appropriate, along with multiple memories and types of memory. Also, multiple computing devices 400 can be connected, with each device providing portions of the necessary operations (e.g., as a server bank, a group of blade servers, or a multi-processor system).

Memory 404 stores data within computing device 400. In one implementation, memory 404 is a volatile memory unit or units. In another implementation, memory 404 is a non-volatile memory unit or units. Memory 404 also can be another form of computer-readable medium, such as a magnetic or optical disk.

Storage device 406 is capable of providing mass storage for computing device 400. In one implementation, storage device 406 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in a data carrier. The computer program product also can contain instructions that, when executed, perform one or more operations, such as those described above. The data carrier is a computer- or machine-readable medium, such as memory 404, storage device 406, memory on processor 402, and the like.

High-speed controller 408 manages bandwidth-intensive operations for computing device 400, while low speed controller 412 manages lower bandwidth-intensive operations. Such allocation of functions is an example only. In one implementation, high-speed controller 408 is coupled to memory 404, display 416 (e.g., through a graphics processor or accelerator), and to high-speed expansion ports 410, which can accept various expansion cards (not shown). In the implementation, low-speed controller 412 is coupled to storage device 406 and low-speed expansion port 414. The low-speed expansion port, which can include various communication ports (e.g., USB, Bluetooth®, Ethernet, wireless Ethernet), can be coupled to one or more input/output devices, such as a keyboard, a pointing device, a scanner, or a networking device such as a switch or router, e.g., through a network adapter.

Computing device 400 can be implemented in a number of different forms, as shown in the figure. For example, it can be implemented as standard server 420, or multiple times in a group of such servers. It also can be implemented as part of rack server system 424. In addition or as an alternative, it can be implemented in a personal computer such as laptop computer 422. In some examples, components from computing device 400 can be combined with other components in a mobile device (not shown), such as device 450. Each of such devices can contain one or more of computing device 400, 450, and an entire system can be made up of multiple computing devices 400, 450 communicating with each other.

Computing device 450 includes processor 452, memory 464, an input/output device such as display 454, communication interface 466, and transceiver 468, among other components. Device 450 also can be provided with a storage device, such as a microdrive or other device, to provide additional storage. Each of components 450, 452, 464, 454, 466, and 468, are interconnected using various buses, and several of the components can be mounted on a common motherboard or in other manners as appropriate.

Processor 452 can execute instructions within computing device 450, including instructions stored in memory 464. The processor can be implemented as a chipset of chips that include separate and multiple analog and digital processors. The processor can provide, for example, for coordination of the other components of device 450, such as control of user interfaces, applications run by device 450, and wireless communication by device 450.

Processor 452 can communicate with a user through control interface 458 and display interface 456 coupled to display 454. Display 454 can be, for example, a TFT LCD (Thin-Film-Transistor Liquid Crystal Display) or an OLED (Organic Light Emitting Diode) display, or other appropriate display technology. Display interface 456 can comprise appropriate circuitry for driving display 454 to present graphical and other data to a user. Control interface 458 can receive commands from a user and convert them for submission to processor 452. In addition, external interface 462 can communicate with processor 442, so as to enable near area communication of device 450 with other devices. External interface 462 can provide, for example, for wired communication in some implementations, or for wireless communication in other implementations, and multiple interfaces also can be used.

Memory 464 stores data within computing device 450. Memory 464 can be implemented as one or more of a computer-readable medium or media, a volatile memory unit or units, or a non-volatile memory unit or units. Expansion memory 474 also can be provided and connected to device 450 through expansion interface 472, which can include, for example, a SIMM (Single In Line Memory Module) card interface. Such expansion memory 474 can provide extra storage space for device 450, or also can store applications or other data for device 450. Specifically, expansion memory 474 can include instructions to carry out or supplement the processes described above, and can include secure data also. Thus, for example, expansion memory 474 can be provide as a security module for device 450, and can be programmed with instructions that permit secure use of device 450. In addition, secure applications can be provided via the SIMM cards, along with additional data, such as placing identifying data on the SIMM card in a non-hackable manner.

The memory can include, for example, flash memory and/or NVRAM memory, as discussed below. In one implementation, a computer program product is tangibly embodied in a data carrier. The computer program product contains instructions that, when executed, perform one or more operations, such as those described above. The data carrier is a computer- or machine-readable medium, such as memory 464, expansion memory 474, and/or memory on processor 452, that can be received, for example, over transceiver 468 or external interface 462.

Device 450 can communicate wirelessly through communication interface 466, which can include digital signal processing circuitry where necessary. Communication interface 466 can provide for communications under various modes or protocols, such as GSM voice calls, SMS, EMS, or MMS messaging, CDMA, TDMA, PDC, WCDMA, CDMA2000, or GPRS, among others. Such communication can occur, for example, through radio-frequency transceiver 468. In addition, short-range communication can occur, such as using a Bluetooth®, WiFi, or other such transceiver (not shown). In addition, GPS (Global Positioning System) receiver module 470 can provide additional navigation- and location-related wireless data to device 450, which can be used as appropriate by applications running on device 450.

Device 450 also can communicate audibly using audio codec 460, which can receive spoken data from a user and convert it to usable digital data. Audio codec 460 can likewise generate audible sound for a user, such as through a speaker, e.g., in a handset of device 450. Such sound can include sound from voice telephone calls, can include recorded sound (e.g., voice messages, music files, and the like) and also can include sound generated by applications operating on device 450.

Computing device 450 can be implemented in a number of different forms, as shown in the figure. For example, it can be implemented as cellular telephone 480. It also can be implemented as part of smartphone 482, personal digital assistant, or other similar mobile device.

Using the techniques described herein, a system is configured to generate an interface hierarchy for use in an auction. The interface hierarchy associates an interface with the various stages of an auction. Through the interface, various methods are exposed that may be used in a stage of the auction.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a display device (e.g., a CRT (cathode ray tube) or LCD (liquid crystal display) monitor) for displaying data to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the engines described herein can be separated, combined or incorporated into a single or combined engine. The engines depicted in the figures are not intended to limit the systems described here to the software architectures shown in the figures.

For situations in which the systems and techniques discussed herein collect personal data about users, the users may be provided with an opportunity to opt in/out of programs or features that may collect personal data (e.g., data about a user's preferences or a user's current location). In addition, particular data may be anonymized in one or more ways before it is stored or used, so that personally identifiable data is removed. For example, a user's identity may be anonymized so that no personally identifiable data can be determined for the user, or a user's geographic location may be generalized where location data is obtained (e.g., to a city, zip code, or state level), so that a particular location of the user cannot be determined.

All processes described herein and variations thereof (referred to as “the processes”) contain functionality to ensure that party privacy is protected. To this end, the processes may be programmed to confirm that a user's membership in a social networking account is publicly known before divulging, to another party, that the user is a member. Likewise, the processes may be programmed to confirm that data about a party is publicly known before divulging that data to another party, or even before incorporating that data into a social graph.

A number of embodiments have been described. Nevertheless, it will be understood that various modifications can be made without departing from the spirit and scope of the processes and techniques described herein. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

1. A method performed by one or more processing devices, comprising:
retrieving information indicative of a plurality of stages in an auction for content items, wherein a stage comprises one or more actions to be performed at a particular point in the auction, and wherein the plurality of stages comprises a first stage in which content items are prepared for participation in the auction, a second stage in which bid prices are compared to publisher pricing information, a third stage in which the content items are ranked, and a fourth stage in which one of the content items is selected as a winner of the auction;
retrieving a data structure hierarchy comprising a plurality of data structures, with the first stage being associated with a first one of the data structures, with the second stage being associated with a second one of the data structures, with the third stage being associated with a third one of the data structures, and with the fourth stage being associated with a fourth one of the data structures;
wherein a data structure, from the plurality of data structures, comprises a structure for exposure of one or more operations at an associated stage and specifies required information for that associated stage, the required information comprising required inherited information that is generated by completion of a previous stage and unavailable to the associated stage prior to completion of the previous stage;
automatically executing the auction in which a content item progresses among the first, second, third and fourth stages independent of maintaining state for the content item by performing operations comprising:
identifying a stage to which the content item has progressed;
assigning a data structure associated with the stage identified to the content item;
receiving the required inherited information for the assigned data structure associated with the identified stage;
performing one or more operations specified by the data structure assigned to the content item using the required inherited information;
automatically populating, based on performing, the data structure assigned to the content item with additional information required for the stage identified;
preventing progression among the first, second, third, and fourth stages based on determining that the inherited information and additional information together are not a valid input to a subsequent stage; and
allowing progression among the first, second, third, and fourth stages based on determining that the inherited information and additional information together are the valid input to the subsequent stage.

2. The method of claim 1, wherein actions of identifying, assigning, performing and populating are repeated until the content item is identified as a winner of the auction or is rejected from the auction.

3. The method of claim 1, further comprising:
determining, based on the data structure associated with the content item, that the content item is a winner of the auction.

4. The method of claim 1, further comprising:
determining, based on the data structure associated with the content item, that the content item is rejected from the auction.

5. The method of claim 4, further comprising:
determining, from the data structure associated with the content item, a reason why the content item is rejected from the auction.

6. The method of claim 1, wherein the content item comprises a first content item, wherein the method further comprises:
identifying a stage to which a second content item has progressed;
associating the second content item with a data structure associated with the stage to which the second content item has progressed;
performing one or more operations specified by the data structure associated with the stage to which the second content item has progressed; and
populating, based on performing the one or more operations specified by the data structure associated with the stage to which the second content item has progressed, the data structure associated with the stage to which the second content item has progressed with required information.

7. (canceled)

8. The method of claim 1, wherein retrieving the information indicative of the plurality of stages comprises:
retrieving a directed graph comprising a plurality of nodes that are ordered in accordance with the stages of the auction;
wherein a node represents a stage;
wherein identifying the stage to which the content item has progressed comprises:
identifying a node that is ordered before other nodes in the directed graph.

9. One or more machine-readable hardware storage devices storing instructions that are executable by one or more processing devices to perform operations comprising:
retrieving information indicative of a plurality of stages in an auction for content items, wherein a stage comprises one or more actions to be performed at a particular point in the auction, and wherein the plurality of stages comprises a first stage in which content items are prepared for participation in the auction, a second stage in which bid prices are compared to publisher pricing information, a third stage in which the content items are ranked, and a fourth stage in which one of the content items is selected as a winner of the auction;
retrieving a data structure hierarchy comprising a plurality of data structures, with the first stage being associated with a first one of the data structures, with the second stage being associated with a second one of the data structures, with the third stage being associated with a third one of the data structures, and with the fourth stage being associated with a fourth one of the data structures;
wherein a data structure, from the plurality of data structures, comprises a structure for exposure of one or more operations at an associated stage and specifies required information for that associated stage, the required information comprising required inherited information that is generated by completion of a previous stage and unavailable to the associated stage prior to completion of the previous stage;
automatically executing the auction in which a content item progresses among the first, second, third and fourth stages independent of maintaining state for the content item by performing operations comprising:
identifying a stage to which the content item has progressed;
assigning a data structure associated with the stage identified to the content item;
receiving the required inherited information for the assigned data structure associated with the identified stage;
performing one or more operations specified by the data structure assigned to the content item using the required inherited information;
automatically populating, based on performing, the data structure assigned to the content item with additional information required for the stage identified;
preventing progression among the first, second, third, and fourth stages based on determining that the inherited information and additional information together are not a valid input to a subsequent stage; and
allowing progression among the first, second, third, and fourth stages based on determining that the inherited information and additional information together are the valid input to the subsequent stage.

10. The one or more machine-readable hardware storage devices of claim 9, wherein actions of identifying, assigning, performing and populating are repeated until the content item is identified as a winner of the auction or is rejected from the auction.

11. The one or more machine-readable hardware storage devices of claim 9, wherein the operations further comprise:
determining, based on the data structure associated with the content item, that the content item is a winner of the auction.

12. The one or more machine-readable hardware storage devices of claim 9, wherein the operations further comprise:
determining, based on the data structure associated with the content item, that the content item is rejected from the auction.

13. The one or more machine-readable hardware storage devices of claim 12, wherein the operations further comprise:
determining, from the data structure associated with the content item, a reason why the content item is rejected from the auction.

14. The one or more machine-readable hardware storage devices of claim 9, wherein the content item comprises a first content item, and wherein the operations further comprise:
identifying a stage to which a second content item has progressed;
associating the second content item with a data structure associated with the stage to which the second content item has progressed;
performing one or more operations specified by the data structure associated with the stage to which the second content item has progressed; and
populating, based on performing the one or more operations specified by the data structure associated with the stage to which the second content item has progressed, the data structure associated with the stage to which the second content item has progressed with required information.

15. (canceled)

16. The one or more machine-readable hardware storage devices of claim 9, wherein retrieving the information indicative of the plurality of stages comprises:
retrieving a directed graph comprising a plurality of nodes that are ordered in accordance with the stages of the auction;
wherein a node represents a stage;
wherein identifying the stage to which the content item has progressed comprises:
identifying a node that is ordered before other nodes in the directed graph.

17. An electronic system comprising:
one or more processing devices; and
one or more machine-readable hardware storage devices storing instructions that are executable by the one or more processing devices to perform operations comprising:
retrieving information indicative of a plurality of stages in an auction for content items, wherein a stage comprises one or more actions to be performed at a particular point in the auction, and wherein the plurality of stages comprises a first stage in which content items are prepared for participation in the auction, a second stage in which bid prices are compared to publisher pricing information, a third stage in which the content items are ranked, and a fourth stage in which one of the content items is selected as a winner of the auction;
retrieving a data structure hierarchy comprising a plurality of data structures, with the first stage being associated with a first one of the data structures, with the second stage being associated with a second one of the data structures, with the third stage being associated with a third one of the data structures, and with the fourth stage being associated with a fourth one of the data structures;
wherein a data structure, from the plurality of data structures, comprises a structure for exposure of one or more operations at an associated stage and specifies required information for that associated stage, the required information comprising required inherited information that is generated by completion of a previous stage and unavailable to the associated stage prior to completion of the previous stage;
automatically executing the auction in which a content item progresses among the first, second, third and fourth stages independent of maintaining state for the content item by performing operations comprising:
identifying a stage to which the content item has progressed;
assigning a data structure associated with the stage identified to the content item;
receiving the required inherited information for the assigned data structure associated with the identified stage;
performing one or more operations specified by the data structure assigned to the content item using the required inherited information;
automatically populating, based on performing, the data structure assigned to the content item with additional information required for the stage identified;
preventing progression among the first, second, third, and fourth stages based on determining that the inherited information and additional information together are not a valid input to a subsequent stage; and
allowing progression among the first, second, third, and fourth stages based on determining that the inherited information and additional information together are the valid input to the subsequent stage.

18. The electronic system of claim 17, wherein actions of identifying, assigning, performing and populating are repeated until the content item is identified as a winner of the auction or is rejected from the auction.

19. The electronic system of claim 17, wherein the operations further comprise:
determining, based on the data structure associated with the content item, that the content item is a winner of the auction.

20. The electronic system of claim 17, wherein the operations further comprise:
determining, based on the data structure associated with the content item, that the content item is rejected from the auction.

21. The electronic system of claim 20, wherein the operations further comprise:
determining, from the data structure associated with the content item, a reason why the content item is rejected from the auction.

22. The electronic system of claim 17, wherein the content item comprises a first content item, wherein the operations further comprise:
identifying a stage to which a second content item has progressed;
associating the second content item with a data structure associated with the stage to which the second content item has progressed;
performing one or more operations specified by the data structure associated with the stage to which the second content item has progressed; and
populating, based on performing the one or more operations specified by the data structure associated with the stage to which the second content item has progressed, the data structure associated with the stage to which the second content item has progressed with required information.

23. (canceled)

24. The electronic system of claim 17, wherein retrieving the information indicative of the plurality of stages comprises:
retrieving a directed graph comprising a plurality of nodes that are ordered in accordance with the stages of the auction;
wherein a node represents a stage;
wherein identifying the stage to which the content item has progressed comprises:
identifying a node that is ordered before other nodes in the directed graph.
